(19) United States
(12) Patent Application Publication
(10) Pub. No.: US 2012/0033705 A1
(43) Pub. Date: Feb. 9, 2012

(54) METHOD AND DEVICE FOR DIAGNOSING A THERMOSTAT

(76) Inventor: Peter Wiltsch, Wimsheim (DE)

(21) Appl. No.: 13/016,478

(22) Filed: Jan. 28, 2011

(30) Foreign Application Priority Data
Feb. 5, 2010 (DE) 10 2010 001 618.7

(51) Int. Cl. G01K 15/00

(52) U.S. Cl. 374/1; 374/E15.001

(57) ABSTRACT

In a method for diagnosing a faulty thermostat in a coolant circuit, in particular for an internal combustion engine, having a fan, the faulty thermostat is detected as a function of a measured temperature and a setpoint temperature, the fan being turned on at least temporarily during the diagnosis.

### CROSS-REFERENCE TO RELATED APPLICATIONS

The present application claims priority to Application No. 10 2010 001 618.7, filed in the Federal Republic of Germany on Feb. 5, 2010, which is expressly incorporated herein in its entirety by reference thereto.

### FIELD OF THE INVENTION

The present invention relates to a method for diagnosing a thermostat, as well as to a computer program, an electrical memory medium, and a control and regulating device.

### BACKGROUND INFORMATION

To comply with the OBDII legislation in the United States, all exhaust-relevant components of a motor vehicle must be diagnosed by the engine control unit. Proof is usually obtained within an exhaust gas test cycle run on a vehicle test stand. Furthermore, a minimum frequency for running the particular diagnostic method must be verified by internal counters within the control unit.

Specifically this also requires detection of a defective engine temperature sensor as well as a sticking, faultily open coolant thermostat in the coolant circuit of the vehicle.

Certain conventional methods diagnose the thermostat on the basis of a modeled expected temperature characteristic of the coolant temperature. These functions are based on models having relatively high tolerances. Therefore, a faultily open thermostat is detectable only when the deviation in the temperature characteristic from the modeled value is also relatively great.

However, specifically in high-power, large-volume engines, there is the problem that they heat up relatively slowly in the exhaust gas test cycle and therefore the temperature difference between faultless operation and operation with a faultily open thermostat does not turn out to be great enough. Reliable diagnosis of a sticking, open thermostat is therefore impossible.

A trip, during which a diagnostic sequence should be possible according to the statutory minimum requirements, results in a slight heating of the engine under some circumstances, so that a diagnosis is problematic.

### SUMMARY

Example embodiments of the present invention provide a method that may ensure an adequate distance between measured and modeled temperatures, in particular during trips resulting in only slight heating of the engine.

A method for diagnosing a faulty thermostat in a coolant circuit having a fan, in which the fan is turned on at least temporarily during the diagnosis, is particularly advantageous because the difference between the particular cooling effects in the case of a faulty thermostat and a faultless thermostat is particularly great due to the fan being turned on.

The method may be particularly easy to implement if the thermostat is closed faultlessly.

In addition, detection of a faulty thermostat is particularly simple if the faulty thermostat is detected as a function of a measured temperature and a setpoint temperature.

Detection of a faulty thermostat is also particularly simple if the fan is triggered after a temperature increase in the coolant with respect to the ambient temperature which is to be defined.

The method may be particularly reliable if the setpoint temperature is ascertained as a function of a second temperature sensed and/or as a function of the operating state of the internal combustion engine.

The method may also be particularly reliable if a faulty thermostat is detected as a function of the curve of the first measured temperature and the curve of the setpoint temperature. It is also particularly expedient if a faulty thermostat is detected when the rise in the first measured temperature is slower than the rise in the setpoint temperature.

The method may be economical in particular when the fan is turned on for the first time before reaching a predefinable temperature, in particular when this predefinable temperature is selected such that a faultless thermostat is still closed.

The method may be inexpensive as an implementable measure because it does not require any additional cost. In particular no additional components, for example, sensors, need be provided.

Further features and aspects of example embodiments of the present invention are described in more detail below with reference to the appended Figures.

### BRIEF DESCRIPTION OF THE DRAWINGS

FIG. 1 schematically illustrates an air-cooled coolant circuit having a fan.

FIG. 2 schematically illustrates time curves of the temperatures with a faultless thermostat and a faultily open thermostat as well as the time curve of the triggering of the engine fan.

FIG. 3 schematically illustrates the sequence of the diagnostic method.

### DETAILED DESCRIPTION

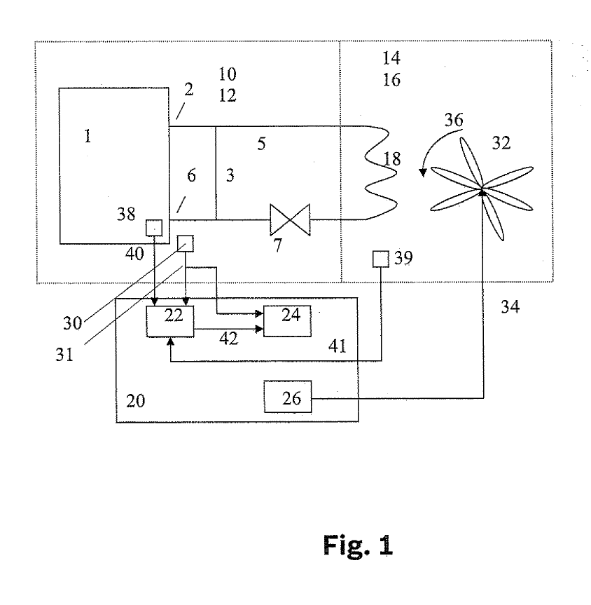

FIG. 1 shows internal combustion engine 1, a first coolant line 3, a second coolant line 5 and a thermostat 7. First coolant line 3 together with a first connection 2 and a second connection 6 forms a first coolant circuit of internal combustion engine 1. Second coolant line 5 together with first connection 2 and second connection 6, a cooler 18, and thermostat 7 forms a second coolant circuit. The first coolant circuit and the second coolant circuit are filled with a coolant such as water. Thermostat 7 switches between first coolant circuit and second coolant circuit. Thermostat 7 is closed at low temperatures and coolant flows through the first coolant circuit and through internal combustion engine 1. Thermostat 7 is opened at high temperatures and coolant flows through second coolant circuit 5 and through internal combustion engine 1.

The first coolant circuit, like internal combustion engine 1, is in a first area 10, which is at a first temperature 12. Second coolant circuit 5 flows through first area 10 as well as a second area 14, which is at a second temperature 16. After prolonged operation of internal combustion engine 1 in particular, first temperature 12 is definitely higher than second temperature 16.

Thermostat 7 is closed when the value of first temperature 12 is below a thermostat-specific threshold temperature. When thermostat 7 is closed, the coolant circulates in the first coolant circuit. There is no cooling by the first coolant circuit. Thermostat 7 opens when the value of first temperature 12 exceeds the threshold temperature. When thermostat 7 is open, coolant circulates in the second coolant circuit. Cooling of the coolant therefore takes place in cooler 18 due to heat exchange with the air in second area 14. The temperature of the coolant is now lower than first temperature 12 in first area 10 and thus withdraws heat from first area 10 via a heat exchange.

FIG. 1 also shows a diagnostic unit 20, which detects whether thermostat 7 is operating faultlessly. In the illustrated exemplary embodiment, a thermostat 7 which is operating faultlessly would be closed and coolant should flow through the first coolant circuit. However, in this exemplary embodiment, thermostat 7 is faultily opened, i.e., coolant flows through the second coolant circuit. Diagnostic unit 20 detects that thermostat 7 is faultily opened.

Diagnostic unit 20 includes a calculation unit 22, a comparator unit 24 and a triggering unit 26. FIG. 1 also shows a temperature sensor 30 and an engine fan 32. Temperature sensor 30 senses first temperature 12 and relays this temperature to calculation unit 22 and comparator unit 24. The value of this first sensed and relayed temperature 12 is referred to as a measured temperature 31. FIG. 1 also shows a temperature sensor 39, which senses second temperature 16 and relays it to calculation unit 22. The value of this sensed relayed temperature 16 is referred to as ascertained ambient temperature 41.

Triggering unit 26 controls engine fan 32 via a triggering signal 34. For example, triggering signal 34 may assume “on” and “off” values. If triggering signal 34 is “on,” engine fan 32 is induced to a rotational movement 36. In this manner, cool air, which is still at second temperature 16, is conveyed into the vicinity of cooler 18 and thus the cooling effect of coolant flowing through the second coolant circuit is increased.

In addition to measured temperature 31, calculation unit 22 receives engine variables 40 from a data unit 38 assigned to internal combustion engine 1, these variables characterizing the prevailing operating state of internal combustion engine 1. Such an engine variable may be in particular the air mass combusted in the internal combustion engine. This is a measure of the total heat generated by the internal combustion engine since a reference point in time (for example, the point in time of the start of the internal combustion engine) and is also a measure of the heating of the internal combustion engine. Data unit 38 may be, for example, a sensor, an engine control unit, or a memory unit of an engine control unit.

Calculation unit 22 ascertains a setpoint temperature 42 from engine variables 40 and measured temperature 31 and relays it to comparator unit 24.

Setpoint temperature 42 corresponds to the expected measured temperature when thermostat 7 is operating faultlessly. Comparator unit 24 checks the deviation in measured temperature 31 from setpoint temperature 42 and decides that thermostat 7 is defective if the deviation between measured temperature 31 and setpoint temperature 42 is too great. Setpoint temperature 42 is calculated in calculation unit 22 with the aid of a model of internal combustion engine 1, for example, which continuously calculates the expected temperature, i.e., setpoint temperature 42, from engine variables 40 and measured temperature 31.

The model first calculates, for example, the heat generated in internal combustion engine 1 by using thermodynamic equations. In a next step, the model calculates the thermal output released by radiation, convection and optionally also thermal conduction and calculates expected setpoint temperature 42 from the heat balance. It is also possible for the model to ascertain expected setpoint temperature 42 with the aid of characteristic curves and characteristic maps, for example, taking into account measured engine variables 40 and measured ambient conditions (for example, ascertained ambient temperature 41).

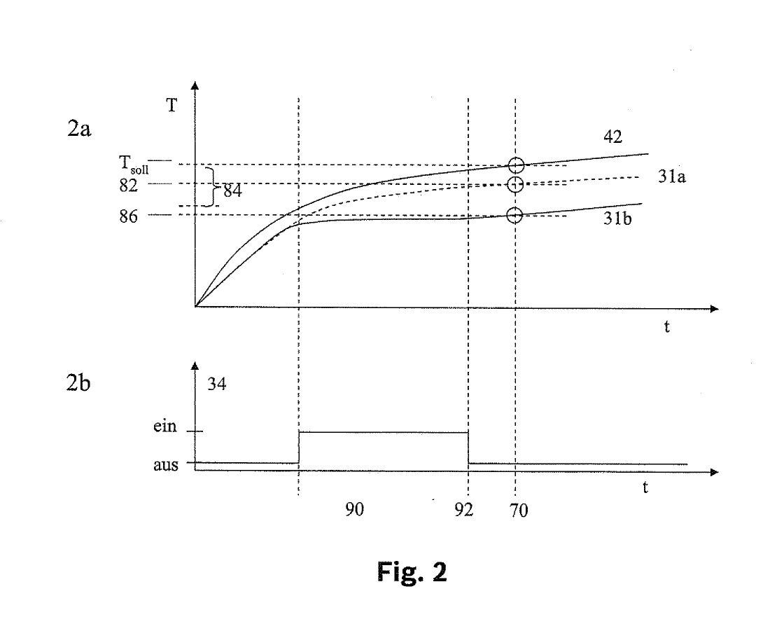

FIG. 2 shows the curve of measured temperature 31 and setpoint temperature 42 for the case when thermostat 7 should be closed faultlessly but in fact is faultily open. Time t is plotted on the abscissa and temperature T is plotted on the ordinate. The time curve of setpoint temperature 42, shown in FIG. 2, is calculated by calculation unit 22 under the assumption of a faultlessly closed thermostat 7. The curve of measured temperature 31 with faultily open thermostat 7 and engine fan 32 at rest is labeled with reference numeral 31a. At a reference point in time 70, instantaneous setpoint temperature Tₛₑₜₚₒᵢₙₜ is compared with measured temperature T_{def}. Measured temperature T_{def} of temperature curve 31a is labeled with reference numeral 82.

The deviation between Tₛₑₜₚₒᵢₙₜ and T_{def} may have various causes. Possible causes include, for example but not exclusively, errors in the model used in calculation unit 22, measurement errors or inaccuracies in temperature sensor 30 in ascertaining measured temperature 31 or a faultily opened thermostat 7. The decision that thermostat 7 is defectively open is therefore possible only if measured temperature T_{def} is lower than setpoint temperature Tₛₑₜₚₒᵢₙₜ by a minimum temperature difference 84. At a sufficiently low first temperature 12, the temperature difference from second temperature 16 is small, the cooling effect of cooler 18 is thus minor, and a defectively open thermostat 7 is not to be differentiated reliably from a correctly closed thermostat 7 by the difference between setpoint temperature Tₛₑₜₚₒᵢₙₜ and measured temperature T_{def}. This case is illustrated in FIG. 2a.

FIG. 2b shows the time curve of triggering signal 34. At the start of the diagnosis, triggering signal 34 corresponds to the “off” value. Engine fan 32 is thus not in motion. Since thermostat 7 is (faultily) opened, coolant is flowing through the second coolant circuit. At a first point in time 90, triggering unit 26 switches triggering signal 34 to “on.” Engine fan 32 then begins to move and increases the cooling power of cooler 18. The particular curve of measured temperature 31 is plotted in FIG. 2a using reference numeral 31b. In comparison with temperature curve 31a when engine fan 32 is at rest, the temperature of temperature curve 31b is much lower. The temperature of temperature curve 31b is all the lower, the lower ambient temperature 41 is and the greater the volume flow is created by the fan.

At a second point in time 92, which may be before or after reference point in time 70, triggering unit 26 again switches triggering signal 34 from “on” to “off.” At reference point in time 70, the value of measured temperature 31 indicated using reference numeral 86 is now different from setpoint temperature Tₛₑₜₚₒᵢₙₜ by more than minimum temperature difference 84. Therefore, a defectively open thermostat is detected.

Reference point in time 70, first point in time 90, and second point in time 92 may be ascertained by taking into account additional variables, for example, in particular the air mass combusted in the internal combustion engine, integrated over time. Second point in time 92 may also be selected in relation to first point in time 90, such that the time difference between second point in time 92 and first point in time 90 exceeds a predefinable time difference as a function of the characteristic of fan 32 and a characteristic cooling power of the second coolant circuit.

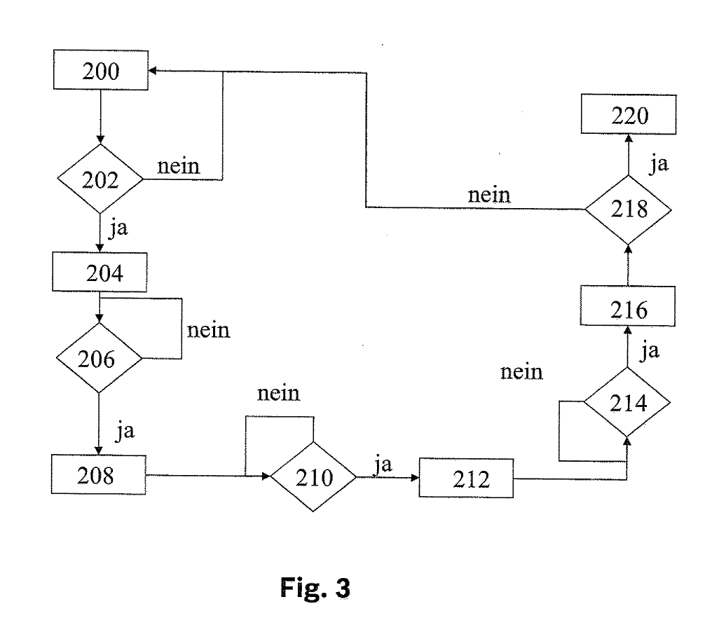

FIG. 3 shows as an example the sequence of the diagnostic procedure in diagnostic unit 20. In step 200, the internal combustion engine is in the normal operating mode. At a point in time 202, there is a check as to whether a diagnosis is necessary (for example, because the last diagnosis was more than a predefined period of time in the past) and whether the diagnostic method may be used, for example, because measured temperature 31 is lower than a predefinable temperature. This predefinable temperature should in particular be lower than the threshold temperature of thermostat 7, so that the thermostat is closed faultlessly. This predefinable temperature may also be reduced in comparison with the threshold temperature, for example, by the maximum increase in measured temperature 31 to be expected through internal combustion engine 1 during the diagnostic procedure or to compensate for exemplary scattering, in particular of the thermostat but also of other components.

If these conditions are met, the method branches off to step 204; if these conditions are not met, the method branches back to step 200. The diagnostic method begins in step 204 and the model in calculation unit 22 is initialized. Step 206 then follows.

In step 206 it is checked whether the time is already more advanced than first point in time 90. Alternatively, it may also check in step 206 whether the difference between measured temperature 31 and ascertained ambient temperature 41 is greater than a predefinable temperature difference. The predefinable temperature difference must be selected as a function of the characteristics of fan 32, such that in the case of a faulty fan, the difference between setpoint temperature Tₛₑₜₚₒᵢₙₜ and ascertained temperature 86 becomes large enough.

If this is the case, the method branches to step 208. If this is not the case, it jumps back to step 206.

In step 208, triggering unit 26 switches triggering signal 34 to “on.” This is followed by step 210. In step 210, it is checked whether the time has already exceeded second point in time 92. Alternatively, in step 210 it may also be checked whether the integrated air mass combusted in the engine has exceeded an air mass threshold value. This air mass threshold value must be selected such that it ensures that the engine has warmed up sufficiently for the expected difference between setpoint temperature Tₛₑₜₚₒᵢₙₜ and measured temperature T_{def} to become large enough in the case of a defectively open thermostat. As another alternative, it may also be checked in step 210 whether temperature difference Tₛₑₜₚₒᵢₙₜ−T_{def} is already greater than minimum temperature difference 84. If this is the case, the method branches further to step 212. If this is not the case, it jumps back to step 210.

In step 212, triggering unit 26 switches triggering signal 34 to “off” and branches further to step 214. In step 214, it is checked whether the instantaneous point in time is later than reference point in time 70. If this is the case, step 216 follows. If this is not the case, the method jumps back to step 214. In step 216 calculation unit 22 calculates setpoint temperature 42 continuously, for example, and relays it to comparator unit 24. Temperature sensor 30 likewise relays measured temperature 31 to comparator unit 24. Comparator unit 24 then calculates the difference between setpoint temperature Tₛₑₜₚₒᵢₙₜ and measured temperature T_{def}. Step 218 then follows in sequence. In step 218 it is checked whether difference Tₛₑₜₚₒᵢₙₜ T_{def} is greater than the predefinable minimum temperature difference. If this is the case, step 220 follows. If this is not the case, step 200 follows again. The diagnostic procedure ends at the end of step 218. In step 220, a faultily open thermostat is now diagnosed. Next an error flag for the engine control unit may be set, for example, setting the engine in emergency operation or outputting an acoustic or visual warning for the driver.

Since reference point in time 70 may be either before or after second point in time 92, the sequence of steps 210, 212 and 214, 216 may be swapped. After step 208, it is thus possible to branch off to step 214, from step 216 to 210 and from step 212 to step 218.

Instead of internal combustion engine 1, any other heat-generating machine may also be used, for example, a fuel cell or a battery.

The comparison of measured temperature 31 and setpoint temperature 42 performed in comparator unit 24 may also take into account the temperatures at more than one reference point in time 70. For example, it is possible to use the integrated difference between measured temperature 31 and setpoint temperature 42 during a comparative period of time to detect a defectively open thermostat.

It is also possible to diagnose a defectively closed thermostat 7. In this case, the model of the temperature trend present in calculation unit 22 must also take into account the influence of rotating engine fan 32. Unlike the exemplary embodiment described here, in which a defectively open thermostat is identified by an unexpectedly high cooling performance, a defectively closed thermostat may be identified by an unexpectedly low cooling performance.

What is claimed is:

1. A method for diagnosing a thermostat in a coolant circuit, comprising:
detecting a faulty thermostat as a function of a measured temperature and a setpoint temperature; and
turning on a fan of the cooling circuit at least temporarily during the detecting.

2. The method according to claim 1, wherein the cooling circuit is arranged as a cooling circuit of an internal combustion engine.

3. The method according to claim 1, wherein the thermostat is closed faultlessly.

4. The method according to claim 1, wherein the setpoint temperature is ascertained as a function of at least one of (a) the measured temperature and (b) characteristic variables of an internal combustion engine that includes the coolant circuit.

5. The method according to claim 1, wherein the thermostat is detected as faulty as a function of a curve of the measured temperature and a curve of the setpoint temperature.

6. The method according to claim 5, wherein the thermostat is detected as faulty when an increase of the measured temperature is slower than an increase of the setpoint temperature.

7. The method according to claim 1, wherein the fan is turned on for a first time before the measured temperature reaches a predefinable temperature.

8. The method according to claim 7, wherein the predefinable temperature is a threshold temperature at which the thermostat begins to open in a faultless state.

9. The method according to claim 1, wherein the fan is turned on when a difference between the measured temperature and an ascertained ambient temperature is greater than a predefinable temperature difference.

10. A non-transitory computer-readable storage medium with an executable program stored thereon, wherein the program instructs a microprocessor to perform a method for diagnosing a thermostat in a coolant circuit, including:
detecting a faulty thermostat as a function of a measured temperature and a setpoint temperature; and
turning on a fan of the cooling circuit at least temporarily during the detecting.

11. A system, comprising:
a diagnostic device of a thermostat of a coolant circuit, the diagnostic device adapted to perform a method including:
detecting a faulty thermostat as a function of a measured temperature and a setpoint temperature; and
turning on a fan of the cooling circuit at least temporarily during the detecting.
